(19) United States
(12) Patent Application Publication
(10) Pub. No.: US 2013/0330388 A1
(43) Pub. Date: Dec. 12, 2013

(54) Porous Sphere-like Objects, Method to Form Same and Uses Thereof Involvoing the Treatment of Fluids Including Anti-bacterial Applications

(71) Applicant: Jainagesh Sekhar, Cincinnati, OH (US)

(72) Inventor: Jainagesh Sekhar, Cincinnati, OH (US)

(73) Assignee: MATTECH, INC., Cincinnati, OH (US)

(21) Appl. No.: 13/906,508

(22) Filed: May 31, 2013

Related U.S. Application Data
(60) Provisional application No. 61/658,508, filed on Jun. 12, 2012.

(51) Int. Cl. E04B 1/76; A01N 25/08; C02F 1/00

(52) U.S. Cl. CPC E04B 1/76; C02F 1/00; A01N 25/08
USPC 424/417; 210/807; 252/62; 424/409

(57) ABSTRACT

A method and resulting structure are described for the production of refractory and insulative boards comprised of ceramic balls. Improved thermal, physical and mechanical properties are achieved as while also eliminating the safety and environmental impact of fibrous refractories. Also presented is an apparatus and method to remove bacteria and toxins (harmful or undesirable chemicals) from a water column utilizing porous ball-like or sphere-like structures treated with anti-microbial coatings are described. The balls so formed may be coated with a variety of anti-microbial materials and placed within a water or fluid column or water or fluid flowing system.

### CROSS-REFERENCE TO RELATED APPLICATIONS

This application claims the benefit of U.S. provisional application No. 61/658,508 filed on Jun. 12 2012. Also, this application utilizes features disclosed in U.S. Pat,. No. 7,880,119 filed on Apr. 5, 2005, U.S. Pat. No. 7,067,775 filed on Feb. 21, 2003 and U.S. Pat. No. 6,099,978 filed on Jan. 28, 1999 and International Patent Applications PCT/US11/34879 filed on May 3, 2011, PCT/US07/85564 filed on Nov. 27, 2007 and PCT/US06/60621 filed on Nov. 7, 2006, the disclosures of all are hereby incorporated by reference in their entirety.

### BACKGROUND-FIELD

This application relates to a method for the manufacturing of porous balls or sphere-like objects during wet mixing of powders. The sphere-like objects produced have high surface and high internal porosity but are not hollow, nor dense. The objects may be fractally dimensioned or have fractal-like dimensions (less than 3, for example, and non-integer) and may be metal, ceramic or plastic. The surface porosity could be connected to the internal porosity. In this manner, they are able to offer thermal insulation properties unlike dense spheres or hollow sphere which conduct along their dense surface. Such objects may also be provided with an antimicrobial coating and used as filter media in water columns and the like.

### BACKGROUND

### Introduction to Insulations

A refractory insulation provides thermal insulation mostly by providing stagnant or “dead” gas space, as it contains a large volume fraction of voids. Refractory insulations are used in the ceramic, steel, aluminum, metal casting and heat treatment industries. The prime criterion for material selection is refractoriness for the specific use temperature and sufficient dimensional stability. The key property for insulating refractory qualification is the service temperature limit (STL), which is related to composition, sinterability, sintering temperature, and void volume. Typical refractories used in high temperature processing are stable oxides and refractory metal compounds, such as Al₂O₃, SiO₂, ZrO₂, CaO, MgO, FeCr₂O₄, SiC, graphite (carbon), borides, carbides, nitrides, silicides and their combinations including ternary and multi element compounds.

Insulating firebricks (IFB) have been the dominant high temperature refractory for a broad range of applications until the development and mass market production of ceramic fiber insulation. Fiber refractories show dramatic improvement over IFB's and also perform exceptionally well in cyclic service. Although the use of ceramic fibers began in the 1960's, there has been steady growth, and over the past ten years fiber refractory quality, type and performance characteristics have significantly improved. Therefore, fiber refractory applications have escalated along with demand and production, while consumption of dense refractories and IFB' s has decreased. Typical applications range from furnace / kiln linings and hot face liners, insulating block modules and blankets, along with increasing demand for special applications to conserve energy and increase yield. Also, due to use in high temperature firings, operating costs are decreasing.

Although fiber refractories have significant benefits over IFB' s, there are considerable undesirable consequences, derived from environmental and health hazards due to production and forming methods and eventual disposal. As mentioned above, there are large quantities of fiber refractories being produced with the amount increasing yearly. The typical refractory lifetime is only approximately five years and, therefore, the quantity of disposable material will be enormous and a problem. This high consumption rate is due to the inherent nature of these types of refractories which results degradation caused by flaking and spalling. As discussed below, there are major health problems associated with fme fiber (<5 μm) usage, and in terms of fiber refractories, problems occur in all stages: from production—to use—to disposal. Table 1 gives typical characteristics of alumina and mullite fibers, which as fme fibers are used in refractory insulations. Therefore, development of a fiber-free refractory, equivalent to current production quality fiber refractories, but without inherent health and environmental hazards, would be highly desirable and create a new and productive market.

TABLE 1
Characteristics of alumina and mullite fibers.

| | Fiber manufacturer | | | | |
|---|---|---|---|---|---|
| | A | B | C | D | E |
| Service temperature | 1600 | 1600 | — | 1500~1700 | 1600 |
| (C. °) | | | | | |
| True Specific | 3.2 | 3.6 | 3.1 | 3.6 | 2.90 |
| gravity | | | | | |
| Fiber diameter (mm) | — | — | 4 | 3 | 2~4 |
| Fiber length (mm) | — | — | 50~100 | — | <50 |

Chemical composition (wt %)

| | | | | | |
|---|---|---|---|---|---|
| Al2O3 | 80 | 95 | 72 | 95 | 72 |
| SiO2 | 20 | 5 | 28 | 5 | 28 |
| Crystal phase* | C, M | C, M | M | C, M | M |

*C: Corundum M: Mullite

### Energy Savings

There are two reasons for interpolating an insulating layer between a hot working chamber and the “outside”. These are: 1) to cool the back face of a roof or wall for safety reasons to a low temperature (Tᵢ), mainly to preserve the mechanical integrity of an enclosing metal shell; and, 2) to reduce the heat flux (J) through the lining and hence improve process fuel economy. In a simple case of a plane wall at steady state, where the hot face temperature (Tₕ) is fixed by a given operation, the heat loss flux J may be easily calculated at steady state as:

J=k_{w}(Tₕ−Tᵢ)/Z_{w}=kᵢ(Tᵢ−T_{b})/Zᵢ=kₛ(T_{b}−Tₒ)/Zₛ=J0 (1)

where: (k_{w}) is the mean thermal conductivity, (Z_{w}) is the mean thickness of the working lining of an insulating lining “i” of (low) mean thermal conductivity (kᵢ) and thickness (Zᵢ); (Tᵢ) is the temperature of the interface between linings “w” and “i”; (T_{b}) is the refractory back face temperature or that of the interface between lining “i” and shell “s”; and, (Tₒ) is the temperature of the outside of the shell. (Jₒ) is the heat flux to the “outside”, existing by virtue of water-cooling or forced or convective air-cooling of the shell. The equation is solvable, given all k's, once Tₒ or Jₒ is fixed. An empirical equation for convective cooling of vertical exterior surfaces by ambient air at 25° C. is approximated by:

Jₒ=0.193 To²+27.25 To−802 (2)

This rough guide applies to a refractory cold face (Tₒ) up to ˜300° C. Good refractories save process energy and manufacturing cost per part. In addition, good refractories improve lot variability and product performance as they aid uniformity of temperature in a furnace.

As an example, suppose that the hot zone of an aluminum melting tunnel kiln averages 1000° C. at the hot face. The working refractory sidewalls and roof are 22.86 cm thick, exposed to the air outside, and are constructed of super duty firebrick, whose mean thermal conductivity is (9.5 Btu.in./ft² hr. ° F. or 490 kJ cm/m²hr ° C.). The heat fluxes can, therefore, be given as:

J=490 (1000−To)/22.86; and, Jo=0.193 To²+27.25 To−802 (3)

If (Tₒ) is 236° C., the heat loss (J) is 16,380 kJ/m² hr. By adding ˜5 cm of lightweight insulation (mean thermal conductivity ˜30 kJ.cm/m hr° C.) to the outside, the heat flux can be given as:

J=490 (1000−Ti)/22.86=30 (Ti−To)/5 (4)

By simultaneously solving equation 4 with the above air cooling equation for (Jₒ), it is shown that (Tᵢ) is equal to 804° C., (Tₒ) is 105° C., and the heat loss (J) is 4,190 kJ/m² hr. This demonstrates that the savings in lost heat at steady state is [(16,380-4,190)/16,380], or very close to 75%. If the kiln hot zone dimensions are 80ft×10ft wide and 12 ft high, the total heat loss area is about 250 m² and the saving in lost heat is about 3 million kJ/hour or 73 million kJ per day, or 69 million Btu per day. That is worth about $120,000 in energy savings alone for one year for one kiln.

In general, interpolating an insulating refractory layer or increasing its effectiveness by decreasing the thermal conductivity: a) increases (TO and decreases (J) at a fixed value of (Tₒ); or, b) increases (Tᵢ) and decreases (Z_{w}) and (Tₒ) at a fixed value of (J). These effects on the cold face temperature of the working lining (Tᵢ) make that lining increasingly vulnerable to corrosion (oxidation). Of the two effects on (Tᵢ), the first is much more pronounced. The temperature of 1000° C. was chosen as it represents a low temperature where the savings are least. With an increase in temperature, the savings increase dramatically. For a 1700° C. furnace, good low thermal conductivity refractories save more than 150 million kJ per day per typical kiln.

In cyclic situations, the numbers are more dramatic. Consider a periodic shuttle kiln, at 1000° C. Each charge of ware plus kiln furniture (or melt charge in a casting situation) consumes 20 million kJ in firing, and an additional 20 million kJ goes up the stack if it is not recovered. The entire cycle occupies 22 hours, leaving two hours per day for charging and discharging. The cycle consists of 12 hours heat-up plus 4 hours steady-state at 1000° C., plus 6 hours of slow cooling. Assume as a basis of comparison: a) 9″ thick free standing superduty firebrick (IFB) refractory walls and roof; and, b) insulating refractory of 9″ thickness backed by sufficiently heavy gauge sheet steel to permit hanging the lightweight lining. The sheet steel will be ignored in order to simplify the heat flow calculations. The required property data for each of these refractories are tabulated below. The wall thickness (Z) in each case is 0.2286 m.

TABLE 2
Firebrick Insulating Refractory comparison.

| | Thermal | | |
|---|---|---|---|
| | Conductivity | Bulk Density | Specific Heat |
| | k, kJ m/m²hr° C. | pb, kg/m³ | c, kJ/kg° C. |
| Firebrick | 4.90 | 2,300 | 0.70 |
| Insulating Refractory | 0.30 | 130. | 0.70 |

TABLE 3
The overall estimated heat consumption in a complete cycle in a kiln.

| | | 9″ Insulating |
|---|---|---|
| Total Heat, 10⁶ kJ | 9″ Dense Firebrick | Refractory |
| Heating/sintering the ware: | 20.0 | 20.0 |
| Lost in the stack (no recycle.): | 20.0 | 20.0 |
| Lost in heating the refractory: | 27.6 | 1.32 |
| Lost through walls in heat-up: | 8.5 | 0.48 |
| Lost through walls at steady state: | 8.5 | 0.65 |
| Total heat consumed/cycle: | 84.6 | 42.5 |
| Process energy efficiency: | 23.5% | 47.0% |

In the above example, data was used for one of the group of low mass fiber refractories, which have drastically changed clean vessel lining practices over the past several decades. The above examples and calculations demonstrate the advantages of fiber refractory insulation over IFB's. These energy savings not only show the advantages of fiber refractory insulation, but show the state of current market and industrial needs and set the standards for the development of new refractory insulations.

The following information is taken from the two reference books:
1) Handbook of Industrial refractory Technology, by Stephan C. Carniglia and Gordon L. Barna, Noyes Publications, ISBN 0-8155-1304-6, Park Ridge N.J., USA, 1992
2) Refractory Handbook, The Technical Association of Refractories, Japan, ISBN 4-925133-01-02, New Ginza Bldg., 7-3-13 Ginza, Chou-ku, Tokyo, 104-0061, Japan.

### Classification of Insulating Refractories

Cellular Type: Cellular refractories are porous, with the term intended to encompass the entire continuum. These type of insulating refractories were established long before the advent of modern refractory fibers. With increasing void volume fraction, the same solid begins to take on the microstructural characteristic of a foam. Insulating firebrick (IFB) dates back well into the 19th century. Modern cellular refractories are made using, singly or in combination, expanded aggregate and an expanded matrix. Steam expansion by flash heating of highly hydroxylated compounds or their aqueous pastes is the most common synthetic process by which low density grains of almost any chemical composition can be made, ranging from clays to silica to alumina and zirconia and their silicates. A further feasible synthetic method is the granulation by drying of a mud containing a particular “burnout” additive; the latter being subsequently removed by combustion. The porous grains are lightly sintered in rotary equipment without collapsing their porosity. Coarse, single size grains provide for relatively open packing. This method however gives a fairly weak strength agglomerate.

Expanded matrix techniques include the same “burnout” method as above, most often using sawdust or other chap cellulose particles of somewhat controlled size. This method is common in making bricks. The other common technique is foaming, ordinarily aided by foam-stabilizing and/or gelling or setting agents. Foaming may be accomplished by: a) frothing, i.e., whipping of air into the mix using beater or whisk techniques; or, b) using a chemical gas forming or “blowing” agent. Such agents include aluminum powder in an acidified mix, liberating H₂, and various combinations of organics or inorganics which react to generate CO₂.

The purposes of expanding grain or aggregate and of expanding a refractory matrix are essentially the same. The two differ mainly in the stage of processing at which each is carried out. The solid structure consists of ligaments or thin walls, largely perforated or fractured by internal gas pressurization and subsequent firing shrinkage. Hence, these materials, although rigid when fired, are relatively weak and friable. They range in resistance to thermal shock from comparable to their dense counterparts at comparable density to shock resistant at high void fractions. This latter resistance results not from any immunity to cracking, but from the isolation of small cracks from one another by empty space and the flexibility or compliance of the remaining thin ligaments. Between medium and high void fractions there is a gradual transition from brittle fracture (e.g., spalling) to disconnected or isolated local tearing. Although cellular refractories are very useful, some critical problems exist which have not been overcome. The limit of use temperature is below 1200° C. because such refractories tend to sinter at higher temperatures. Densification increases the thermal conductivity and associated hardening leads to machinability problems and low thermal shock resistance. To overcome these drawbacks fiber refractories have been developed.

Fiber Type: For the great majority of fiber insulation cases, molten silicates are spun or blown into long fibers in the vitreous state, a condition then preserved by rapid under-cooling of the viscous liquid. This is precisely the method by which fiberglass refractories are made. In addition to vitreous fibers, a few crystalline fibers are made. Most notable are alumina and cubic stabilized zirconia. One manufacturing method consists of impregnating a synthetic porous polymer filament with aqueous aluminum or zirconium hydroxychloride, then carefully drying and burning out the organic and crystallizing the oxide. These ceramic fibers are extremely fine, running between 3 and 6 microns in diameter. The crystal size is of the order of a few tenths of one micrometer. Fiber compositions in use include these expensive crystalline oxides as well as mechanical mixtures of crystalline and vitreous fibers and vitreous alumina-silica compositions ranging from 70% Al₂O₃. Some alumina chromia silica vitreous fibers are also made. Much of the “zirconia” fiber insulation made is actually A-Z-S, but genuine cubic ZrO₂ (with Y₂O₃) is also used for obtaining the best performance. Numerous inorganic spray coating slurries have been developed. These are used not only to bond fibers together but also to increase the resistance to gas phase chemical attack. Restrictions on the use only in benign chemical environments have been considerably relieved by virtue of either fiber compositions or coatings and have been an important advance.

The typical immediate product of fiberization is a loose or open but tangled mass of interpenetrating filaments and compacted somewhat, yielding a “wool.” This unbonded form is known as fiberglass. If it is further mechanically compacted and sprayed with a resin or inorganic binder the material becomes a bonded “felt”, and is easily handled, flexible and elastic. Some felts are “needled” to increase the density of tangles without bonding. Whether backed on one side with flexible sheet or foil, or not, products ranging from wool to felt are sold as batting and blanket or molded blanket, or as gasketing strips. Completing the progress of densifying, thick layers of wool are rolled out, binder-sprayed, and then vacuum-pressed between large platens to make rigidly-bonded board, which can be cut into convenient modular sizes for the or brick. Spray-coating with a refractory slurry is used to seal the hot face. Vacuum forming has been extended to the making of all manner of intricate and hollow yet rigid shapes such as for catalytic burners, electric heating element embedment, cylindrical coil liners, metal hanger insulation, and custom molded components. Wool materials can be made at very low bulk densities, with void fractions as high as 0.99. But with so little solid, there is almost no impedance to convection and radiation which are important components of heat transport through the gas space.

An important advantage of fiber technology is that the fiber matrix does not completely densify, and through the various processing methodologies listed above, various shapes and densities can be easily formed. This is another critical factor in development of new or improved technology, in that processing should be variable and the material does not densify, even at use temperatures.

### Service Temperature Limit (STL)

Service temperature limit (STL) is used in conformance with industry practice for insulating refractories. A permanent linear shrinkage of each material commences at some temperature and increases with increasing temperature above that limit. The contributions to this shrinkage are aggravated by the large empty volume existing in insulating products. All formed cellular materials are distinctly under sintered and re-heating continues those unfinished processes. Glass fibers are also subject to thermal re-crystallization and crystal growth.

The makers and users of insulating refractories in the US have agreed on maximum allowable re-heat shrinkage. Standards in ASTM classification for cellular firebrick and for cellular insulating aluminous or alumina silica castables exists. Simultaneous maximum limits are also placed on bulk density. Fiber refractories are classified voluntarily by their makers. Early linear shrinkages of about 2-5% may be anticipated in service at the recommended STL, and must be provided. The range of STL for fibers exceeds that for cellular refractories, starting lower and ending higher (1870° C.). Fiber refractories have a higher STL and lower bulk density, for the higher (>1600° C. refractory) and even lower for the lower temperature refractories.

### The Serious Problem With Fiber Refractories

The serious problem with fiber refractories is the inhalation health hazard of most refractory fibers. The hazard pertains to manufacture, handling and disposal of fiber products, which are always toxic and dangerous when airborne. Fibrous insulation materials cause airborne fibers during manufacture, use and disposal. As previously shown in Table 1, the typical fiber used in refractory production is the very short (<4 μm) and most likely to become airborne. However, there are no known substitutes to fiber containing insulation for very high temperatures and even at low temperatures, such as home insulation, pressed fibers are often employed. About 1 fiber/cc per 8 hour exposure is a level which is commonly thought to be dangerous. Manufacturers of refractory fibers and refractories/insulation containing fibers take great pains to educate users on the dangers of fibers. The use of face and body masks is highly recommended. Fiber refractories have been classified as class 2B (high carcinogenic possibility) by the International Agency for Research on Cancer. Possibly, only because good alternatives do not exist, there has not been a bigger uproar similar to the asbestos problem. The only difference between fibers used for high temperature insulation and asbestos, apart from a small difference in diameter, relates to the fiber fracture mode during mechanical deformation.

The cost of using elevated temperature fiber refractory is high due to the expense of: 1) the fiber materials; 2) the fabrication, machining and handling; and, 3) the liability risk associated with selling short fibers. Products which use fiberous insulation are, therefore, very expensive. As an example, a simple laboratory 12″×12″×12″ ceramic furnace operating at 1800° C. costs ˜$20,000 (year 2004 prices), mostly from the refractory cost, which is often a often unaffordable cost. In addition, during use of high temperature kilns and furnaces, there is the real danger of airborne fiber from the refractory when opening doors or placing samples (charge) in the furnace. Disposal concerns are also coming to the forefront, for as production of fiber refractories escalates, so do associated replacement parts, leading to higher costs and increased health/environmental issues. Due to the fact that fiber refractories are so effective, it is anticipated that millions of tons will be produced, but millions of tons will also need disposal.

### Fiber Free Refractories For Use Up To 1850° C.

A technique and composition was given in a recent Patent U.S. Pat. No. 6,113,802 which could give a high temperature refractory insulation with all the desirable “alumina properties”. A pilot study has led to a product of very low density, useful as an insulation. Many compositions were tried and it was found that a complicated initial composition with nano-sized colloidal alumina particles was required (other dispersed nano-structures may work as well). The addition of carbon powder to the initial composition was found to be a key factor in making such an insulation. Another key benefit came from the addition of different particle sizes of the carbons and different particle sizes of the refractory powder. As is subsequently shown, the material exhibits machinable character with good thermal shock resistance. In addition, because of the high seemingly stable porosity, the products of this novel substance should possess extremely low thermal conductivity. For product development, other important refractory considerations are listed below.

For a 1700° C. rated furnace, a preferred insulation would:

have a high melting point greater than 1800° C.

be non-fiber containing to reduce harmful fiber emissions

be easily machinable and not hard (ability to be shaped with hand tools)

have low density (<1.5 g/cc)

have high thermal shock resistance (no shattering on rapid cooling - ensuring long life)

be usable in short duration up to temperatures close to the melting point (survive run-away furnace temperature and faulty controllers)

have low thermal conductivity (<1.5W/mK at a median temperature of ˜1000° C.)

have very low electrical conductivity (<0.1/(ohm cm).

Although fiber refractories are the best available today in terms of STL, non-toxic materials which meet all the criteria given above are not available. This is the object of the present application. Current insulation materials normally contain fibers which are all dangerous to humans. U.S. Pat. No. 6,113,802, which is incorporated herein in its entirety by reference, teaches a composition to make high temperature insulating refractory to make insulation without fibers. In addition, the special refractory so formed is found to have a mean thermal conductivity of <0.4 W/mK, allowing for significant possible energy savings, as subsequently shown.

### Potential Impact of New Refractory / Comparison to Fiber Refractory

### Energy Savings:

An approximate analysis of energy savings is as follows. The total Ceramic+Powder Metallurgy+Casting+Aluminum+Steel+electronic materials is about $200 billion. Of this, $5.9 billion is in the heat processing capital equipment market.

### Energy Savings Comparison of Insulations:

Insulation Materials: As a rule of thumb for $10,000 of capital equipment, a loss of ˜10 kW of power during use may be expected. Therefore, $5.9 Billion corresponds to a loss of 5.9×10⁸ kW. Assume 200 days of use every year, then 200×24×5.9×10⁸×kWh/year is energy lost through fibrous materials. As shown in the example in the introduction, this figure can nearly be doubled if traditional refractory was the one being replaced. Assume fibrous refractory on the average has (k - thermal conductivity) of 0.6 W/mK.

Although the general class of cellular refractories is known to be safer than fibrous refractories, the fiber refractories allow for the creation of significantly higher dead space without undue sintering of the refractory. Fiber refractories possess a higher STL making them the preferred materials of choice for insulating applications.

### SUMMARY

A method of eliminating fibers (like asbestos) and yet have the ability to achieve high thermal insulation is needed. Herein is described such a method. The method consists of making very porous balls for use instead of the more commonly used fibers. A way of making porous balls from powders is taught in this application. In the past, all methods of making balls e.g. discussed in Patents such as U.S. Pat. No. 3,975,194 (hollow spheres with a wall), CA 1131649 (dense ceramic balls), U.S. Pat. No. 4,621,936 (dense ceramic balls (porosity less than 8%)), were employed to either make very dense balls (which because of a lack of porosity cannot be used as good insulators) or were made into hollow spheres which are weak and also have non porous surfaces and thereby conduct well along the surface. The hollow spheres of the type described in U.S. Pat. No.3,975,194 (hollow spheres with a wall), have 100% internal porosity.

In the present application compositions of U.S. Pat. No. 6,113,802 are made into refractory by the step of forming balls and thereby produce the following: a refractory with a high STL which is seemingly able to reach the current fiber board limits; a cellular or fiber free refractory that has the important benefit that no health or environmental concerns apply as with fiber refractory insulations; a material that is easily made; and a new methodology in which ceramic refractory materials can reaction-bond without densification. When balls are introduced, the densification is naturally further suppressed because of limited contact between balls. As densification proceeds by diffusion, the limited contact greatly increases the diffusion distance leading to much lower densification.

The precise reason for the new fiber free refractory to display such unusual properties is unclear at this time. However, it is clear that the refractory works because sintering (densification) is impeded even at high temperatures. Two main theories are being considered: 1) the forces which cause atom movement are relieved by local grain growth instead of neck growth which normally causes coarsening (sintering) this processes is greatly influenced by ball formation; and, 2) the sequence of product forming reactions especially where carbon is involved leads to an efficient kinetic barrier for atom movement which otherwise could cause sintering. As noted below, ball refractories substantially may be used to decrease thermal conductivity by the manipulation of packing.

The present application also presents a method, structure and apparatus for the anti-microbial, anti-bacterial, anti-fungal and anti-biofilin treatment of water and other fluids. The removal of chemical pollutants from such fluids is also anticipated. Porous sphere-like objects as described above may be partially or entirely composed of anti-microbial materials or may be coated with anti-microbial materials. Water or other fluids could subsequently be passed through a bed of such sphere-like objects and be cleansed of a variety of undesired organisms after contact with the objects. A means and apparatus for the treatment of fluids utilizing a canister containing anti-microbial is contemplated and presented below. Such sphere-like objects may also have fractal surfaces or dimensions which increase the surface area of the objects and assist in the removal of chemical and other pollutants. Anticipated anti-microbial materials and methods to produce the same and anti-microbial coatings are found in U.S. Patents 7,880,119, 7,067,775 and 6,099,978, International Patent Applications PCT/US11/34879, PCT/US07/85564 and PCT/US06/60621, the disclosures of all are hereby incorporated by reference in their entirety.

### DRAWINGS—FIGURES

FIG. 1 shows a photograph of the spherical-like balls made of the composition given in Table 4. These balls were fired in a furnace at about 1550° C. The average size of the balls is about 3mm.

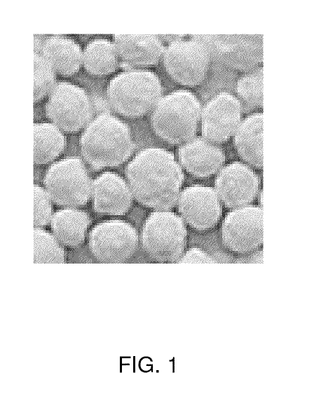

FIG. 2 shows FIG. 2 illustrates an anticipated embodiment of an apparatus for the anti-bacterial treatment of a water column.

DRAWINGS - Reference Numerals

| | | |
|---|---|---|
| 10. anti-bacterial filter | 20. canister | 24. inlet |
| 26. outlet | 30. anti-bacterial media | |

### DETAILED DESCRIPTION

When production of large pieces was attempted using the composition found in U.S. Pat. No. 6,113,802 it was realized that only a few pieces were successful and generally thicknesses over about 5mm were difficult to make unless they had another very small dimension, or drying was carried out slowly over a period of weeks. Therefore, a new method (this application) was developed to make larger boards with larger thickness. In the context of this application a board may be any three dimensional configuration shaped from the named or described processes. A tendency to crack during drying is a known common problem in the making of ceramic materials that are mixed in solution and then dried. Steam drying, with high temperature and even superheated steam is feasible. However, this limits the sizes of ceramics and refractories made and dried in this manner. The cracking problem is particularly severe when several different components are mixed. The components often dry at different rates, thus causing stresses which cause cracks. Normally only very thin or small size symmetrical parts are made from ceramics (such as cylinders etc.). In the current application, non-uniform drying and the stresses related to such an effect is reduced. One method that allows the thickness of slurry processed ceramics to be increased is the additions of binders such as PEG or PVC to the wet mixes.

It has been found that the best way to make larger boards was first to make tiny ceramic balls (spherical or oblong) and then press them together in a die when the whole mix was still wet. It was found that any size board could be made by this method with much larger thicknesses. The small ball like pieces acted as crack blunters. It was learned that almost all the ceramic mixes with the right amount of water which were mixed vigorously (with the correct amount of mixing time) tended to form balls. Table 4 and Table 5 show the composition and method used to make spherical balls and boards.

Small samples approximately 6″×6″×6″ were made and tested for limited material properties. A summary of the best properties measured to date is presented below:

TABLE 4
Refractory Alumina Materials for Working Temperature of 1700° C.

| Powder Average | Particle Size | Purity | Source |
|---|---|---|---|
| Al | −325 mesh | 99.5% | JM, Cat No: 11067 |
| C | −300 mesh | 99.0% | JM. Cat No: 10129 |
| C | +40 mesh | unknown | SG |
| Mg/SiO₂ | 5 m | 99.5% | JM. Cat No: 13024 |
| Al₂O₃ | −325 mesh | unknown | Alcoa 325-LI |
| Al₂O₃ | −48 mesh | unknown | Alcoa 48-LI |
| Al₂O₃ | 60 nm colloid | unknown | CN |

TABLE 5
Process Steps for Manufacture of 0.5 kg Ball Refractory

(i) Rotary Mill for 12 hr - 500 g starting mixture and 50 ml deionized
water - using adequate (>10 times powder weight) amount of hard
zirconium oxide balls in glass container.
(ii) Air dry for 12 hours after milling
(iii) Intermittently add colloidal alumina (60 nm colloid) and Methyl
Cellulose to dried material, and thoroughly mix.
(iv) In this step, balls were automatically formed after mixing for a
duration longer than about 5 minutes.
(v) Press resultant material (i.e the sphere like balls) in die at 5 psi
(vi)Due to contained water - The green compacted samples undergo a
two-step drying scheme: 1) compacted samples air dried for 12 hrs; and, 2)
placed in a 200° C. furnace for 12 hrs.
(vii) Sintering of pressed material at about 1600° C. for use up to 1850° C.

TABLE 6
Sample Physical Properties

| | |
|---|---|
| Density: | 1.2 g/cm3 |
| Porosity: | 65-80% volume percent. |
| Refractoriness: | ~1850° C. |
| Color: | White |
| Fiber content: | Nil |

TABLE 7
Sample Mechanical Properties

| | |
|---|---|
| Machinability: | Easily machinable (cut with knife or hand saw) |
| Flexural Strength: | ~6.50 (MPa) |
| Elastic Modulus: | ~3.00 (GPa) |

TABLE 8
Sample Thermal Properties

| | |
|---|---|
| Linear Thermal Expansion | From crude heating trials. This was |
| | concluded to be similar or lower than fibrous |
| | refractory (~10⁻⁶/C.°). |
| Thermal Conductivity | Approximately 0.30(R.T. −450° C.) |
| | (cm²/sec) |
| | Will depend on ball packing for a given |
| | material. |
| Thermal Diffusivity | To be measured (R.T. −450° C.)(W/m. °K) |
| | Will be dependent on ball packing for a |
| | given material. |
| Specific Heat, Cₚ | To be measured (cal/g. °K) |
| Thermal Shock Resistance | 8.8 (Retained Strength %) (from 1100° C. |
| | to water quench) |

Best Method: For the composition discussed above it was found that a ball size of 3-4 mm yielded the most appealing board for insulations. Boards are the most common form of insulation material in use for temperatures above 1300° C.

Examples of Most often Practiced Technique;
(1) The composition given above (Table 4) was mixed with water. 4 Kg of mix was prepared. This was rapidly mixed and after about five minutes little balls began to form (mixing time between 5-30 minutes). The longer the mixing time the bigger was the ball size. After the ball size reached 4 mm the mixture was poured into a die, dried and then fired at 1700° C. to yield a 1800° C. useful insulation board 12″×12″×1″ in size. After firing, the board was seen to have a density of 1.2 g/cc and was hard and thermally resistant. The board was successfully employed as a furnace roof in a 1600° C. furnace.
(2) The composition given above (Table 4) was mixed with water. 6 kg of mix was prepared. This was rapidly mixed and after about five minutes (5-30minutes) little balls began to form. The longer the mixing time the bigger was the ball size. After the ball size reached 4 mm the mixture was poured into a die, dried and then fired at 1700° C. to yield a 1800° C. useful insulation board pyramid 12″×12″ in size at the base and 4″×4″ at the top of the multi-step pyramid. After firing, the board was seen to have a density of 1 g/cc and was hard and thermally resistant. The board was successfully employed as a multi-step door in a 1600° C. furnace.

When stacking balls of the same size, the most efficient method of packing, which gives a classical face centered cubic structure or a hexagonal closed packed structure, it is well known that a maximum of 0.74 of the total volume can be occupied. When stacked in a manner of a simple cubic lattice, about 0.52 of the total volume may be occupied. In a random manner, for example, when spheres are stacked in a simulated glassy lattice with holes, the packing efficiency (ratio of total volume occupied) is less than 0.4. This is well known in the literature. Thus, with the ball refractory, in addition to the porosity inside each ball, the overall packing efficiency can be low, leading to a method in which the overall thermal conductivity can be very low. This may be an explanation for the low thermal conductivity noted in Table 8.

BET surface area is a commonly used term with powders and is an important property for many types of advanced materials powders. BET stands for Brunauer, Emmett, and Teller, the three scientists who optimized the theory for measuring surface area. BET characterizes powder more effectively than particle size and is commonly reported for powders.

Table 5 gives an anticipated method for producing ball refractories. In general it was found that this method requires slow addition of the liquid. In addition, we observe that too much liquid causes a paste and too little makes the mix appear very powdery. In describing the anticipated method, it is felt that the following limitations are pertinent:
1. Liquid (Fluid) Content Range: 16% to 28% (May contain anti-microbial and anti-biofilin species that particularly enhance fractal ball formation. Nano-dispersions of anti-microbial species are considered as well.)
2. Particle size:-325 mesh to -48 mesh (44-300 micron) The powder mass may be comprised of alumina, carbon, silica and anti-microbial species as well.
3. Mixing time: 15 min to 1 hours
4. BET: 0.3-70 m2/g

It was also observed that when the balls are poured into a die to dry, the right amount of pressure is required to retain the shape of the balls while making extended shapes. Too little, and they don't stick together. Too much and the ball shapes are lost. For the composition described above, the pressure while pressing the board should be between 0.75 psi (very low) and 50 psi (medium) to retain the shape of the balls. There appears to be an optimum speed of mixing as well. If the mixing speed is too low, large clumps form. Likewise, if the speed is too high, a paste forms. Mixing velocities in the bowl of 0.2-200 cm/sec were used in experimental studies. The use of powder which is flowery tended to make ball formation easier.

In summary, therefore, a method has been discovered where balls of insulation form easily during the mixing step. These balls are found to be stable, such that, they may be poured into a die, dried then fired. Such a method yields porous materials which have applications in insulations whereby non-fiber containing material may be used to form parts of unlimited size and unique shapes. Other applications are also envisaged for acoustic damping, structural parts, thermally shock resistant parts and general ceramic parts for kiln use, crucibles, substrates, ducts, membranes, semiconductor substrates, etc.

The ball size is controllable by the liquid content and mixing time. Shapes from the balls may be made by pouring the balls into a die or directing a jet of balls into a structure or cavity that needs to be covered. Small size balls may also be used to make coatings and other substrates applied directly or indirectly to other materials for a variety of purposes in the metallic arts such as steel industry or other industries requiring ceramic coating.

An advantage of the balls is that they flow and fill spaces; yet dry without cracking, thereby overcoming a serious problem previously faced by the ceramic industry. Thus, they can be made into in-situ insulation especially around prefabricated or sinterable heating elements. The word ball is used loosely to encompass shapes such as oblong or irregular pellet shapes of small agglomerated powder.

### Theory For Extended Objects

It may be well anticipated that ball refractories and ceramics are the only way to make large parts from slurry (aqueous and non-aqueous) processing where a liquid is mixed with solid mostly powder in the presence of air, other gasses or vacuum. In a theoretical study by L. L. Hench, Ceramic Processing before Firing, Wiley, New York, p. 261, it is pointed out that drying limits crack-free thickness of parts by the equation:

w=(9D.s/j.v.E) (5),

where w is the maximum thickness of a slab which can be dried without cracking, D is the diffusivity of the water (solution) at the surface of drying, s is the fracture stress of the material, E is the elastic modulus of the material, j is the water evaporation flux and v is the Poisson ratio. For common vales of ceramic materials, especially those relevant to insulation materials, D-10-4 cm2/s and j is in the order of 10-6 cm3/cm2 s, and after correcting for spheres in place of slabs, this equation predicts thicknesses of the order of ˜1-10 mm. Thus, it is difficult to make boards of higher thicknesses without cracks unless they are made by stacking balls of this diameter. This theory seems to validate what has observed experimentally above by the applicants.

As described above, a method to manufacture balls of ceramics by mixing compositions containing liquid agents, both aqueous and non-aqueous, has been described. It was found that under certain conditions, balls were noted to form instead of paste in most systems tried, i.e. with alumina, zirconia, magnesia, Al,Mg,Zr,Si ceramic compounds including oxides and silicates including those containing C, SiC, Cr₂O₃, Si₃N₄, salons, refractory borides, carbides, nitrides, combinations, compounds and mixtures. Typical refractories used in high temperature processing are stable oxides and refractory metal compounds, such as Al₂O₃, Si0₂, Zr0₂, CaO, MgO, FeCr₂O₄, SiC, graphite (carbon), borides, carbides, nitrides, silicides and their combinations including ternary and multi element. The use of the balls to form shapes such as plates, cylinders and non-symmetrical shapes is anticipated. Thus, non-fiber containing insulating refractories made by this method are possible. Insulations for heat as well as electricity are envisaged. Kiln furniture, substrates, etc. may be made by this method. Anticipated is the use of ball ceramics (spherical porous ceramics) in engine parts, electronics, acoustic dampers, shock absorbers, ducts for fluids and gasses, decorative consumer parts, etc. Also anticipated are partly paste and partly balls in the mixture.

When discussing porous sphere-like objects included are porous needles and ellipse like objects in the definition. Aspect ratios of 1.5 to 3 are covered in the porous sphere description.

As-Coated Usage with and in Fluids

The applicants have developed a new use for such sphere-like objects described in the present application. Such objects may be treated or incorporated with anti-microbial, anti-bacterial and anti-biofilm coatings that can be used for the removal of toxins, chemicals and microorganisms from water columns and other water supplies. It is envisioned that such anti-bacterial coatings may include, but are not exclusive to, barium and oxides, rare earths, silver and transition elements and oxides. These sphere or ellipse-like objects may be in a range of micron to centimeter in size. Such objects would be then coated with nano-scale materials having anti-bacterial properties. The antimicrobial particles may be attached to the sphere-like objects in a weld-like manner (as described in U.S. Pat. No. 7,880,119 which is incorporated by reference in its entirety) or created or grown in situ on the sphere-like objects. The sphere-like objects may be formed utilizing the method disclosed above wherein antimicrobial compounds or materials are added during or after the mixing process thereby creating antimicrobial spheres without the need of a further antimicrobial coating. These sphere-like objects may be fractally dimensioned as well, or may be comprised of fractally dimensioned pores or surfaces. Surfaces may be faceted or non-faceted. The objects may be described as nano-structured, micro-structured or milli-structured. These nano-structures may be anti-microbial themselves or be enhanced with other anti-microbial materials added during the initial mix or after the formation of the sphere-like objects. The anti-bacterial coating or chemical mixture of the sphere-like objects can have a no-permanent chemical life in order to improve efficacy of different objectives at different times of storage and use. Such a case would be where hydrogen peroxide (H₂O₂) is included in the mixture and in time dries up leaving nascent oxygen which has been shown to be effective in the treatment and control of various microbes.

In one embodiment, the sphere-like objects could be placed in a tubular vessel or canister with an inlet and an outlet for fluid such as water. The container would be filled with the anti-bacterial coated objects and water or other fluids would be introduced through the inlet and exit through the outlet after passing through the sphere-like objects in the vessel. The water passing through this water/fluid column would thus be purified of bacterial toxins via the anti-bacterial action of the coating on the spheres. As such, the column acts as a filter mechanism and cleans water or any fluid passing through the vessel. The vessel could be configured so that gravity acts to feed the fluid through the column or pressure may be used to push the fluid through.

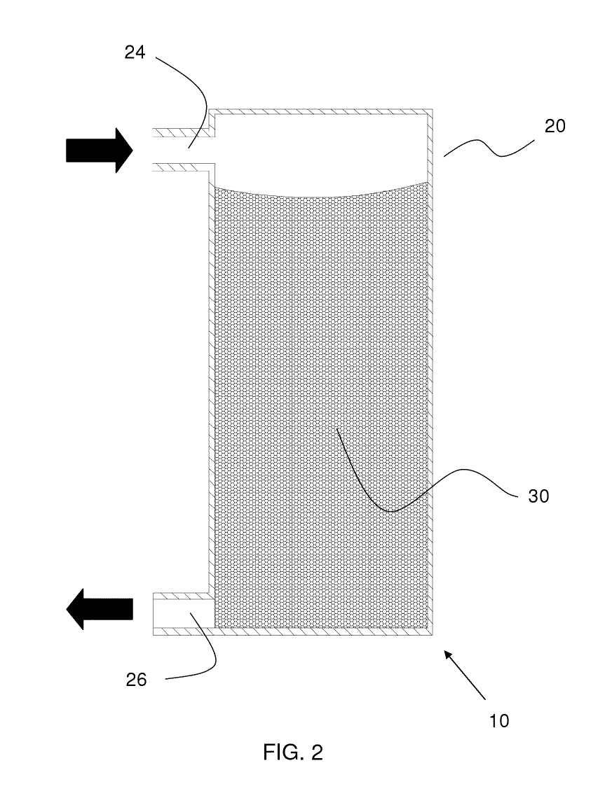

It is anticipated that such units could be sized and configured for industrial, institutional or domestic use or wherever bacteria free water is needed. Such filtering means would be invaluable in environments where bacteria or biofilms (fungal, bacterial or other types) are often present in the drinking or cleaning water supply. In many cases water that was too contaminated for drinking and washing could be passed through the described apparatus and reclaimed, leading not only to improved health, but also to more efficient usage of scarce water supplies. FIG. 2 illustrates an anticipated embodiment of an apparatus for the anti-bacterial treatment of a water column. The apparatus or anti-bacterial filter 10 is composed of a canister 20 having an inlet 24 and an outlet 26. Water or other fluids is introduced through the inlet of the canister after which it passes through the anti-bacterial media 30 that is composed of anti-bacterially coated spherical objects as described above. Bacteria are destroyed as the water comes in contact with the media. After passage through the media the water is removed via the outlet of the canister and can be utilized where bacteria free water is needed. The water or fluid can pass through the canister under only the force of gravity or it could be forced through under pressure.

It is anticipated that the media could be removed and replaced with fresh media when necessary or the entire canister could be designed in a manner allowing for the complete replacement of the canister containing the spent media. The media itself could be placed within the canister loosely or contained within a flow-through pouch or other packaging allowing for quick and simple removal.

The coating may be applied to the sphere-like objects utilizing the apparatus and method described in U.S. Pat. No. 7,880,119 entitled “One Sided Electrode for Manufacturing Processes Especially for Joining” or PCT/US07/85564 entitled “Antimicrobial Materials and Coatings and Method for Using Same” which are included here in its entirety. An electrode composed of the anti-bacterial material will produce an arc and be consumed while at the same time depositing a coating of the anti-bacterial material upon a substrate which in this case are the sphere-like objects. It is also anticipated that the balls themselves may be composed of antibacterial materials that would impart antibacterial effects without the need for coating.

This process consists of creating an extremely high potential localized point in a material which will continuously disintegrate and discharge when it experiences very high frequency alternating (sine wave type) current, thus producing heat and heated mass either during or subsequent to the discharge. This is called a once sided electrode method. No second electrode is required. If a work-piece is involved such as for example a welding fixture or a substrate to be coated, it does not have to be grounded in any manner. The discharge can take place to open air or gas or any other dielectric fluid which has a low electrical conductivity. The alternating current can have a variety of other frequencies superimposed on (Fourier deconvolution).

By creating an immense potential point, an unstable situation is created which can lead to a metallic discharger apparatus proposed herein or the proposed method of discharger. The basic theory of operation of the metallic discharger is as follows: The metallic discharger can be created with the use of a modified high powered high frequency generator having a frequency preferably, but not limited to, in the range from 0.001 to 1000 Megahertz. For example a modified amplifier is connected to an output tank coil which is in a parallel resonant circuit (also commonly called a pi circuit) which, when tuned to resonance has a very high impedance and consequently high voltage across it. If the electrode is very fme the voltage moves to the end of the electrode. This high, potential energy had no place to go other than out at the end point of a wire or attached fme rod which projects into the atmosphere. This energy, as it rushed out at the small end point of the rod, causes the rod to get red hot and emit an arc like discharge.

It was discovered that the characteristic of the metallic discharger could be used as a way of making particles which can cause welding or coating because they posses both heat and kinetic energy in the discharge. Electrodes consisting of antimicrobial materials could be discharged and attached to sphere-like objects in this weld-like manner.

In such a manner particles and coatings with antimicrobial and antibiofilm properties may be applied. Exemplary embodiments of the present invention can provide durable nanoporous nanostructures with antibiofilm properties. Such structures can include, e.g., microscopic and/or nanoscale (i.e., 1 mm=1000 microns [μm]=10⁶ nm or 1 μm=1000 nm) particles of certain materials which may be strongly bonded to a substrate and/or to each other. Preferred nanostructures are nanoporous (i.e., have pores less than 1000 nanometers [i.e., sub-micron] in size) and are comprised of nanoparticles of MoSi₂ and/or similar materials and mixtures thereof which may be inorganic and when applied as a coating have a nanoscale thickness. The coatings may be porous or otherwise not fully sintered or densified. Anticipated techniques allow for multi-compositional structures and layers with different compositions during or after ball formation. Mixed mode coatings, i.e., nanoporous and chemical gradients are possible. The nanoporous structures may be chemically or mechanically active or have a potential gradient (i.e., a gradient in charge, solute, magnetism, electrostatics, heat, etc. through the structure). The basics of this process are also presented in PCT/US 11/34879 which is also included by reference in its entirety.

It is anticipated that the porosity of the sphere-like objects will collect chemicals and other contaminants from fluids or other flows that may pass through over or around a bed of such objects. This type of cleaning would be accomplished without a coating, whether anti-bacterial or not, primarily due to the porosity of the objects.

Residence time (the time that a fluid is in contact with a surface) can be controlled by the size or extent of the sphere-like objects or the extent and type of the porosity in the objects (i.e. at the surface) or by tortuosity and path selective features and friction of the surface that control residence time, angle and time of contact. It is anticipated fully that residence time manipulation may be engineered to continuously improve the efficacy. Similarly, in situ fouling or repair and enhancement are anticipated.

What is claimed is:

1) A method of forming porous sphere-like objects, wherein the objects may be fractally dimensioned, the method comprising mixing of a powder mass with a liquid, wherein the powder has a BET number between about 0.3-90 m2/g, wherein the liquid content ranges liquid from about 16% to 28%, wherein the surface porosity of the resultant objects is greater than 15%, and wherein the internal porosity is between about 15% and 95%.

2) The method of claim 1 further comprising air drying.

3) The method of claim 1 wherein the mixing step is for a duration longer than 5 minutes.

4) The method of claim 2 further comprising intermittently mixing a dispersed nano-structure and methyl cellulose after the air drying.

5) The method of claim 4 wherein the dispersed nano-structure is comprised of colloidal alumina.

6) The method of claim 1 wherein the powder mass comprises alumina and carbon.

7) The method of claim 1 wherein the powder mass comprises silica.

8) The method of claim 1 wherein the liquid comprises colloids.

9) Porous sphere-like objects comprising a powder mass into which a liquid is mixed wherein the powder has a BET number between about 0.3-90 m2/g, and wherein the liquid content ranges from about 16% to 28% and wherein the surface porosity of the objects is greater than 15%, and the internal porosity of the objects is between about 15% and 95%.

10) The porous sphere-like objects of claim 9 wherein the liquid is an anti-microbial material or a nano-dispersion.

11) The porous sphere-like objects of claim 9 wherein the powder mass comprises alumina and carbon and anti-microbial species.

12) The porous sphere-like objects of claim 9 wherein the powder mass comprises silica and anti-microbial species.

13) The porous sphere-like objects of claim 9 wherein the liquid comprises colloids and other nano-dispersions.

14) The porous sphere-like objects of claim 9 further comprising an anti-bacterial coating.

15) A method for the treatment of fluids comprising the passing of the fluids through a bed of porous sphere-like objects wherein the sphere-like objects may be fractally dimensioned.

16) The method of 15 wherein the porous sphere-like objects are produced by a method consisting of mixing of a powder mass into which a liquid is mixed and the powder has a BET number between about 0.3-90 m2/g, the liquid content ranges liquid from about 16% to 28% and the surface porosity of the resultant objects is greater than 15%, and the internal porosity is between about 15% and 95%.

17) The method of 15 wherein the porous sphere-like objects are coated with an anti-bacterial coating thereby further subjecting the fluids to an anti-bacterial treatment.

18) The method of 15 wherein the bed of porous sphere-like objects are contained within a canister, the canister having an inlet and an outlet allowing for the fluids to flow through and in contact with the bed of porous sphere-like objects.

19) The method of 15 wherein the objects are coated with an anti-bacterial coating.

20) The method of 15 wherein the objects are comprised of anti-bacterial materials.
